(19) United States
(12) Patent Application Publication
(10) Pub. No.: US 2020/0307184 A1
(43) Pub. Date: Oct. 1, 2020

(54) MAPPING ACTUATION SIGNALS TO ACTUATORS

(71) Applicant: Hewlett-Packard Development Company, L.P., Spring, TX (US)

(72) Inventors: Vincent C. Korthuis, Corvallis, OR (US); Eric Martin, Corvallis, OR (US)

(73) Assignee: Hewlett-Packard Development Company, L.P., Spring, TX (US)

(21) Appl. No.: 16/763,245

(22) PCT Filed: Dec. 21, 2017
(86) PCT No.: PCT/US2017/068005

§ 371 Date: May 12, 2020

(51) Int. Cl. B41J 2/045

(52) U.S. Cl. CPC B41J 2/04546; B41J 2/04515; B41J 2/04551; B41J 2/04591; B41J 2/04563; B41J 2/04586; B41J 2/04553

(57) ABSTRACT

In some examples, a fluidic die comprises a plurality of actuators and actuation control logic coupled to the plurality of actuators. The fluidic die also includes a multiplexer, coupled to the actuation control logic, to provide the actuation control logic with an actuation signal, the actuation signal to control operation of the plurality of actuators. The fluidic die also comprises an actuation signal generator, coupled to the multiplexer, to provide the multiplexer with a plurality of actuation signals. The fluidic die also includes actuation signal mapping logic to control the multiplexer and the actuation signal generator based on one of a plurality of stored modes, each mode mapping the plurality of actuation signals to the plurality of actuators.

### BACKGROUND

Actuation systems include fluidic dies on which various components, such as fluid actuators, are positioned. Actuators may use heater resistors to warm the fluid within the actuators to form a fluid vapor that subsequently causes a liquid, such as ink, to be deposited on a target medium, such as paper. The degree to which a heater resistor warms the fluid in a corresponding actuator depends in part on the amount of current that flows through that heater resistor. Current flow through a heater resistor is often controlled using a switch, such as a transistor. The switch, in turn, is controlled using actuation signals.

### BRIEF DESCRIPTION OF THE DRAWINGS

Various examples will be described below referring to the following figures:

FIG. 1 shows an example actuation system in accordance with various examples.

FIGS. 2A and 2B show additional example actuation systems in accordance with various examples.

FIG. 3 shows another example actuation system in accordance with various examples.

FIGS. 4 and 5 show flow charts of example methods of mapping actuation signals to actuators in an actuation system in accordance with various examples.

### DETAILED DESCRIPTION

Masks may be used to configure the routing (or “mapping”) of actuation signals to actuators on fluidic dies in actuation systems. Each mask provides a different mapping of actuation signals from an actuation signal generator to a set of actuators. It is often desirable to implement different mappings in different instances of what are otherwise electrically equivalent fluidic dies. To implement different mappings, however, different masks are used. Changing masks is a tedious, costly, and generally undesirable task.

Described herein are various examples of systems and methods for dynamically mapping actuation signals to target actuators, thereby mitigating the need for masks. In some examples, a fluidic die includes an actuation signal generator that generates multiple actuation signals. These signals may be pulsed signals that vary from each other in terms of pulse width, for example. The fluidic die also includes an actuation signal mapping logic to control the actuation signal generator and a multiplexer (which maps the actuation signals to target actuators) based on a selected mapping mode. The actuation signal mapping logic selects a mapping mode, either on its own or on command from another system component, and provides control signals to the actuation signal generator and the multiplexer to implement the selected mode. The fluidic die also includes actuation control logic assigned to a group of actuators based on a commonality, such as actuators having a common fluidic architecture (e.g., actuators producing a certain drop size, actuators that are ejecting vs. microfluidic) or actuators belonging to a common fluid slot, to a common fluid slot column, to a common rib, or to a common array of ink feed holes. The actuation control logic receives the actuation signals from the multiplexer and applies the actuation signals to the corresponding actuators. In this manner, the fluidic die implements a dynamically modifiable actuation signal mapping scheme, which is less expensive and less tedious than using traditional masks.

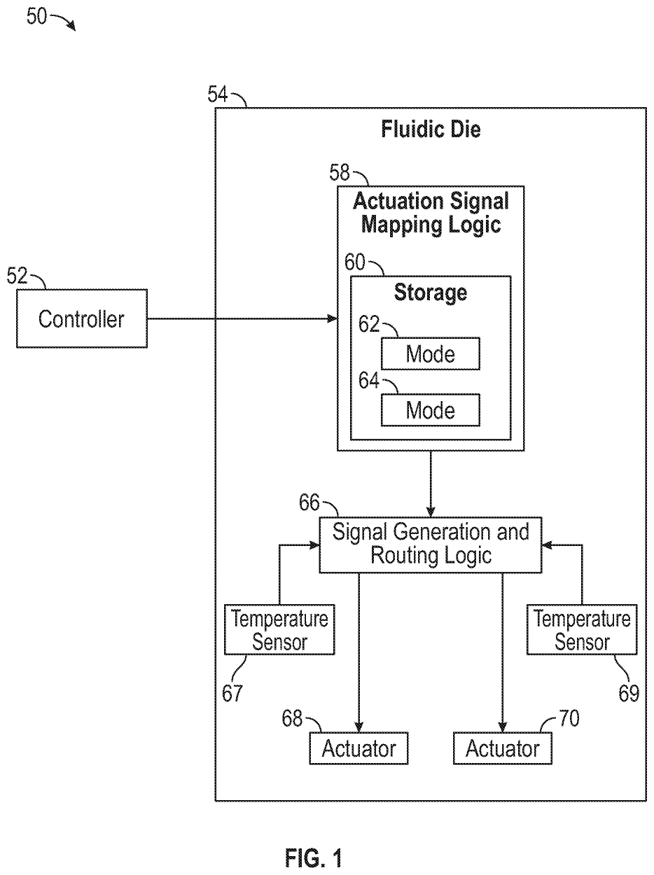

FIG. 1 depicts an example actuation system 50—for example, a printing system. The actuation system 50 includes a controller 52, such as a processor, that receives data from various components (e.g., sensors) of the actuation system 50 and controls various aspects of the actuation system 50. The actuation system 50 also includes a fluidic die 54. In some examples, the fluidic die 54 includes actuation signal mapping logic (ASML) 58, signal generation and routing logic (SGRL) 66, a plurality of actuators 68, 70, and a plurality of temperature sensors 67, 69. Although two actuators 68, 70 are shown, any number of actuators may be used. Similarly, although only two temperature sensors 67, 69 are shown, any number of temperature sensors may be used. In addition, different types of sensors may be used in lieu of temperature sensors, such as sensors to measure environmental conditions or the condition of the actuators 68, 70. The ASML 58 includes storage 60, such as random access memory (RAM), read-only memory (ROM), volatile or non-volatile memory, or any other suitable type of storage.

The storage 60 includes multiple modes 62, 64. Each mode is, for example, a digital representation of a specific mapping of actuation signals between the SGRL 66 and the actuators 68, 70, as described in additional detail below. Modes may be defined based on features of the actuation system 50. For example, a mode may be defined based on which fluidic architecture is used for actuators. Modes may be based on the columns in which actuators are arranged on either side of fluid slots, meaning that the mode causes certain actuation signals to be mapped to actuators based on the columns to which those actuators belong. Similarly, in some examples, a mode may be defined based on ribs to which actuators belong, meaning that the mode causes certain actuation signals to be mapped to actuators based on the ribs (i.e., spaces between fluid slots, as depicted below) to which those actuators belong. In some examples, a mode may be defined based on the fluid slots to which actuators correspond, meaning that the mode causes certain actuation signals to be mapped to actuators based on the fluid slots around which those actuators are positioned. In some examples, a mode may be based on the array of ink feed holes in which the actuators are positioned, meaning that the mode causes certain actuation signals to be mapped to actuators based on the array of ink feed holes to which those actuators correspond. Other types of modes are contemplated and included within the scope of this disclosure. Modes may be programmed, for example, by a designer of the actuation system 50 or may be uploaded after the actuation system 50 has been manufactured.

In operation, the ASML 58 selects a mode based on various factors, such as information provided by the controller 52 regarding system conditions. In some examples, the temperature sensors 67, 69 provide temperature data to the controller 52, and in such examples, the controller 52 may provide commands to the ASML 58 based on the temperature data, thereby enabling the ASML 58 to include temperature data in selecting a mode. The ASML 58 is programmed to select modes as desired based on any of a variety of factors.

The ASML 58 provides a signal or signals to the SGRL 66 indicating the selected mode. In turn, the SGRL 66 generates actuation signals and maps the actuation signals to the actuators 68, 70 based on the selected mode. For example, assume that the mode 62 defines a mapping in which a first actuation signal is to be mapped to actuators in actuator column 1 and a second actuation signal is to be mapped to actuators in actuator column 2. If the actuators 68, 70 both are positioned in column 1, the SGRL 66 would map the first actuation signal to both actuators 68, 70, and it would not map the second actuation signal to either of the actuators. If the actuators 68, 70 are positioned in columns 1 and 2, respectively, the SGRL 66 would map the first actuation signal to the actuator 68 and would map the second actuation signal to the actuator 70.

As described above, the actuation signals control switches (e.g., metal oxide semiconductor field effect transistors (MOSFETs)) which, in turn, control current flow through heater resistors that heat fluid in the actuators 68, 70. In some examples, each actuator contains a heater resistor, and each heater resistor corresponds to one switch. In some examples, the actuation signals are pulsed signals, with logic HIGH signals closing the switch and logic LOW signals opening the switch. In some such examples, increasing the pulse width or frequency (i.e., duty cycle) in the actuation signal increases actuation energy, and decreasing these parameters decreases actuation energy. In some examples, actuation energy may be adjusted by adjusting actuation signal frequency or pulse width.

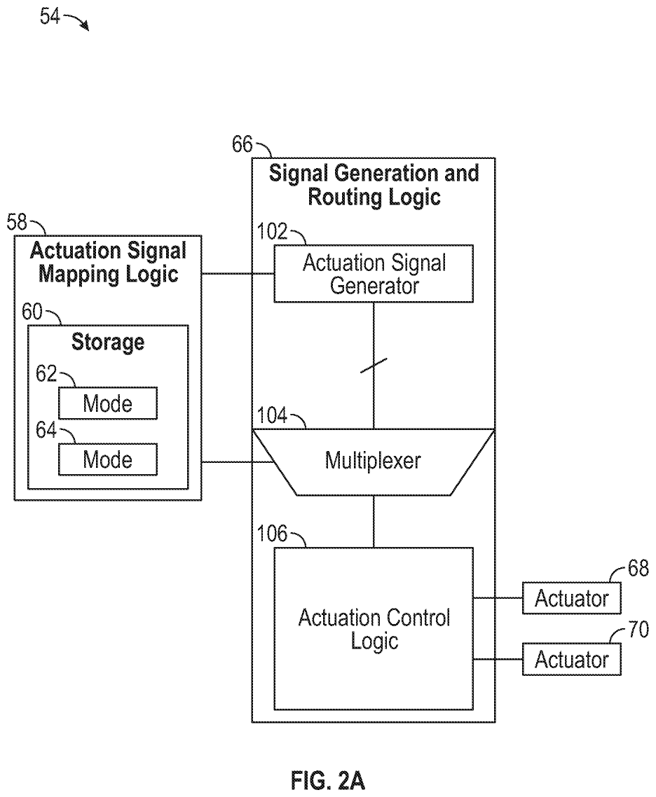

FIG. 2A shows another example actuation system in accordance with various examples. More particularly, FIG. 2A depicts aspects of the fluidic die 54 of FIG. 1. The fluidic die 54 includes the ASML 58 and the actuators 68, 70, each of which is described above. In addition, the fluidic die 54 includes an actuation signal generator 102, a multiplexer 104, and actuation control logic 106. FIG. 2B shows the example actuation system of FIG. 2A, but with temperature sensors 67, 69 positioned near actuator 68 and providing temperature data to the actuation signal generator 102. Referring to FIGS. 2A and 2B, the actuation signal generator 102 generates actuation signals. The actuation signal generator 102 may, for example, be programmed to generate signals in a particular manner, such as based on the temperature readings of temperature sensors 67, 69 that are located in various areas of the actuation system 50. In some cases, the actuation signal generator 102 may determine that the actuator 68 is overheating, as indicated by the temperature readings from the temperature sensors 67, 69. In such a situation, the actuation signal generator may generate actuation signals that have lowered pulse width or frequency, thus decreasing energy used to actuate the actuator 68. Similarly, pulse width or frequency can be increased for firing actuators at low temperatures. In some examples, the actuation signal generator 102 is controlled by the ASML 58. The multiplexer 104 receives a plurality of actuation signals from the actuation signal generator 102, and it maps the received actuation signals to the actuation control logic 106 (and to other actuation control logics in addition to the actuation control logic 106) based on a mode indicated by the ASML 58.

For example, if the ASML 58 selects the mode 62, the ASML 58 outputs a multiplexer control signal to the multiplexer 104 based on the mode 62, and it provides command signals to the actuation signal generator 102 based on the mode 62. The actuation signal generator 102 thus generates actuation signals based on the mode 62, and the multiplexer 104 maps input actuation signals to the actuation control logic 106 (and to other actuation control logics) based on the mode 62. The actuation control logic 106 corresponds to and controls the actuators 68, 70, so the multiplexer 104 sends actuation signals intended for the actuators 68, 70 to the actuation control logic 106. Other actuators may be controlled by other actuation control logic, and, in such cases, the multiplexer 104 sends actuation signals intended for these actuators to their respective actuation control logic.

Because the actuators 68, 70 are controlled by the same actuation control logic 106, FIGS. 2A-2B assume that the actuators 68, 70 share a common classification of some kind. For example, the actuators 68, 70 may belong to the same column of actuators alongside a fluid slot; they may be in different columns but correspond to the same fluid slot; they may be associated with different fluid slots but correspond to the same rib between fluid slots; they may correspond to a common array of ink feed holes; or they may have similar fluidic architectures. Other variations are contemplated and included in the scope of this disclosure.

The actuation control logic 106, in some examples, uses actuation signals received from the multiplexer 104 to control the actuators 68, 70 in tandem with other factors. For example, in printing applications, the intended pattern to be printed on the target medium (e.g., paper) may define actuator 68 to be on but actuator 70 to be off. In such a scenario, the actuation control logic 106 may receive an actuation signal from the multiplexer 104 that is to be distributed to the actuators 68, 70, but because actuator 70 is to be off, only actuator 68 receives the actuation signal. The actuation control logic 106 may use a variety of factors to determine the manner in which it will distribute actuation signals to the actuators 68, 70.

FIGS. 2A-2B depict one multiplexer 104, one actuation control logic 106, and two actuators 68, 70. In some examples, different numbers of multiplexers, actuation control logics, and actuators may be used. The particular topology of multiplexers, actuation control logics, and actuators may vary and may be implemented as desired to implement a target actuation signal mapping scheme.

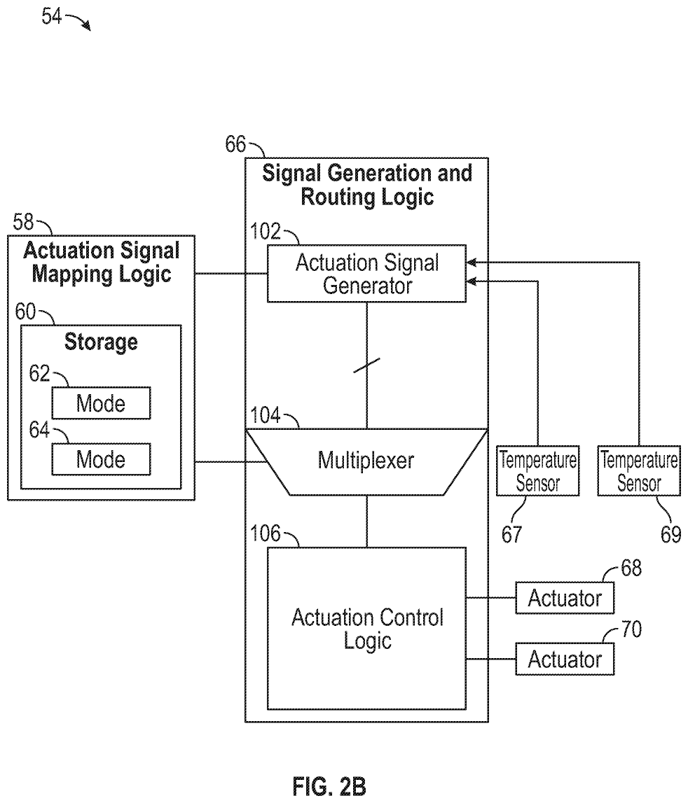

FIG. 3 shows another example actuation system in accordance with various examples. In particular, FIG. 3 depicts an expanded version of the fluidic die 54 shown in FIGS. 2A-2B. In FIG. 3, the fluidic die 54 includes multiple multiplexers 104a, 104b; fluid slots 300, 302; actuators 68a-68d, 70a-70d, 72a-72d, and 74a-74d; and actuation control logic 106a-106d. The actuators 68a-68d form one column; actuators 70a-70d form another column; actuators 72a-72d form a third column; and actuators 74a-74d form yet another column. The actuators 68a-68d and 70a-70d correspond to the same fluid slot 300, while the actuators 72a-72d and 74a-74d correspond to the same fluid slot 302. The actuators 70a-70d and 72a-72d correspond to the same rib—i.e., the area between the fluid slots 300, 302. Actuators 68a-68d correspond to another rib, while actuators 74a-74d correspond to a third rib. The multiplexer 104a maps actuation signals to the actuation control logics 106a, 106b, and the multiplexer 104b maps actuation signals to the actuation control logics 106c, 106d.

Still referring to FIG. 3, in one example, the mode 62 may define a mapping of actuation signals generated by the actuation signal generator 102 such that actuation signals are mapped by column—e.g., each of the columns of actuators receives a different actuation signal. In such a case, the ASML 58 controls the actuation signal generator 102 and the multiplexers 104a, 104b such that each of the actuation control logics 106a-106d receives a different actuation signal. In another example, the mode 64 may define a mapping of actuation signals generated by the actuation signal generator 102 such that actuation signals are mapped by rib—e.g., each of the ribs of actuators receives a different actuation signal. In such a case, the ASML 58 controls the actuation signal generator 102 and the multiplexers 104a, 104b such that the actuation control logic 106a receives a first actuation signal, the actuation control logics 106b-106c receive a second actuation signal, and the actuation control logic 106d receives a third actuation signal. Other mappings are contemplated and included within the scope of this disclosure.

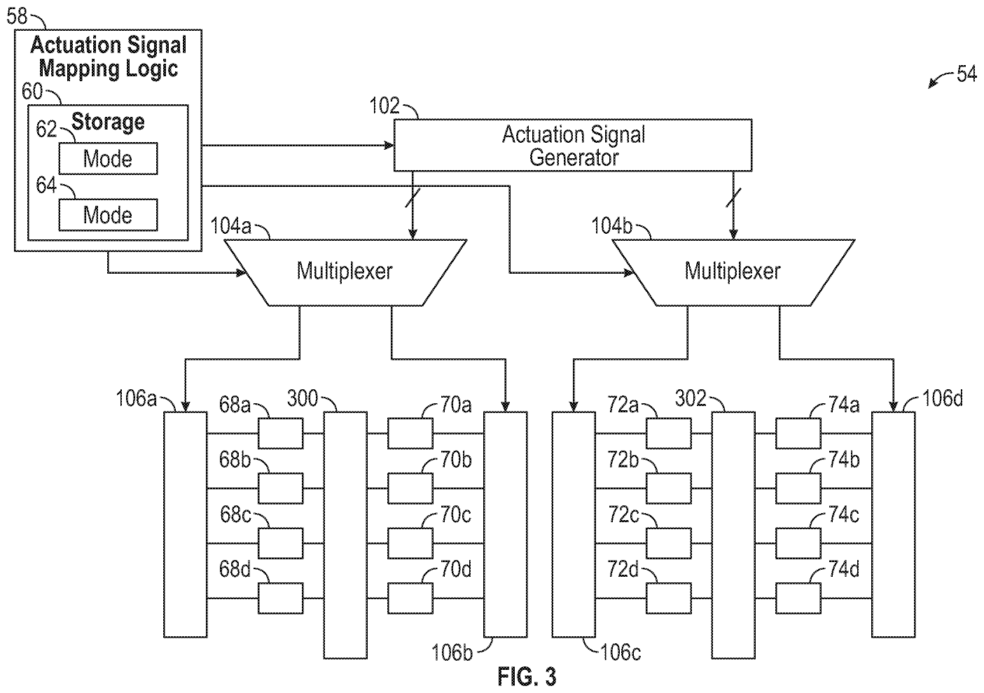

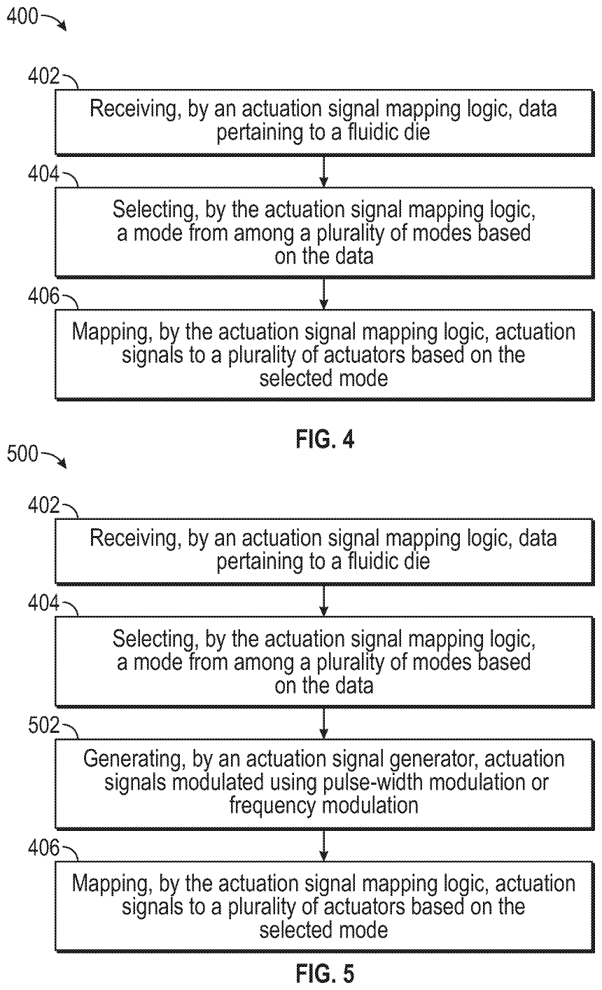

FIG. 4 shows a flow chart of a method 400 of mapping actuation signals to actuators in an actuation system in accordance with various examples. The method 400 may be performed, for example, by the actuation system 50 described and depicted with respect to FIGS. 1-3. The method 400 begins with receiving, by an actuation signal mapping logic, data pertaining to a fluidic die (step 402). The method 400 next includes selecting, by the actuation signal mapping logic, a mode from among a plurality of modes based on the data (step 404). The method 400 further comprises mapping, by the actuation signal mapping logic, actuation signals to a plurality of actuators based on the selected mode (step 406). The method 400 may be modified as desired, including by adding, deleting, modifying, and/or rearranging steps. For example, as shown in FIG. 5, the method 400 may be modified to include step 502 to produce a method 500, which includes generating, by an actuation signal generator, actuation signals modulated using pulse-width modulation or frequency modulation, as described above.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A fluidic die comprising:
a plurality of actuators;
actuation control logic coupled to the plurality of actuators;
a multiplexer, coupled to the actuation control logic, to provide the actuation control logic with an actuation signal, the actuation signal to control operation of the plurality of actuators;
an actuation signal generator, coupled to the multiplexer, to provide the multiplexer with a plurality of actuation signals; and
actuation signal mapping logic to control the multiplexer and the actuation signal generator based on one of a plurality of stored modes, each mode mapping the plurality of actuation signals to the plurality of actuators.

2. The die of claim 1, wherein, to control a current passing through a heater resistor in one of the plurality of actuators, the actuation signal generator is to modulate a pulse width of the actuation signal.

3. The die of claim 2, wherein the actuation signal generator is to modulate the pulse width of the actuation signal based on a temperature associated with the fluidic die.

4. The die of claim 1, wherein, to control a current passing through a heater resistor in one of the plurality of actuators, the actuation signal generator is to modulate a frequency of the actuation signal.

5. The die of claim 1, wherein, in a first mode of the plurality of stored modes, the actuation signal mapping logic is to cause the actuation signal generator and the multiplexer to provide the actuation signal to the actuation control logic based on a column with which the plurality of actuators is associated.

6. The die of claim 1, wherein, in a second mode of the plurality of stored modes, the actuation signal mapping logic is to cause the actuation signal generator and the multiplexer to provide the actuation signal to the actuation control logic based on a rib with which the plurality of actuators is associated.

7. The die of claim 1, wherein, in a third mode of the plurality of stored modes, the actuation signal mapping logic is to cause the actuation signal generator and the multiplexer to provide the actuation signal to the actuation control logic based on a fluid slot with which the plurality of actuators is associated.

8. A method comprising:
receiving, by an actuation signal mapping logic, data pertaining to a fluidic die;
selecting, by the actuation signal mapping logic, a mode from among a plurality of modes based on the data; and
mapping, by the actuation signal mapping logic, actuation signals to a plurality of actuators based on the selected mode.

9. The method of claim 8, wherein the data is selected from the group consisting of a temperature associated with the fluidic die and a configuration of print heads associated with the fluidic die.

10. The method of claim 8, wherein each of the actuation signals is to control an amount of energy applied to each of the plurality of actuators.

11. The method of claim 8, comprising the actuation signal mapping logic mapping the actuation signals to the plurality of actuators according to a column with which the plurality of actuators is associated.

12. The method of claim 8 comprising the actuation signal mapping logic mapping the actuation signals to the plurality of actuators according to a rib with which the plurality of actuators is associated.

13. The method of claim 8 comprising the actuation signal mapping logic mapping the actuation signals to the plurality of actuators according to a fluid slot with which the plurality of actuators is associated.

14. A fluidic die comprising:
a plurality of actuators;
an actuation signal generator to generate actuation signals to control the plurality of actuators; and
an actuation signal mapping logic to store a plurality of modes, each mode associated with a different mapping of the actuation signals to the plurality of actuators,
wherein the actuation signal generator is to dynamically modulate the actuation signals in response to a measured temperature.

15. The die of claim 14, wherein the actuation signal generator is to modulate the actuation signals using a modulation technique selected from the group consisting of frequency modulation and pulse width modulation.
